(19) United States
(12) Patent Application Publication
(10) Pub. No.: US 2020/0173378 A1
(43) Pub. Date: Jun. 4, 2020

(54) INTERNAL COMBUSTION ENGINE SYSTEM

(71) Applicant: TOYOTA JIDOSHA KABUSHIKI KAISHA, Aichi-ken (JP)

(72) Inventors: Masamitsu KOYASU, Nagoya-shi (JP); Yukihiro NAKASAKA, Shizuoka-ken (JP); Shigeki MIYASHITA, Susono-shi (JP)

(21) Appl. No.: 16/679,312

(22) Filed: Nov. 11, 2019

(30) Foreign Application Priority Data
Dec. 4, 2018 (JP) 2018-227427

(51) Int. Cl. F02D 13/04; F02D 13/02; B60W 10/18

(52) U.S. Cl. CPC F02D 13/04; B60W 10/18; F02D 13/0261

(57) ABSTRACT

An internal combustion engine system includes a fuel injection valve, a variable valve operating device and a control device. The control device is configured, where depression of an accelerator pedal is released, to: execute a fuel cut processing to control the fuel injection valve so as to stop fuel injection; and execute an engine braking enhancement processing to control the variable valve operating device so as to advance the opening and closing timings of the exhaust valve compared to during execution of the fuel injection. The engine braking enhancement processing includes a noise reduction processing to adjust at least one of the closing timing of the exhaust valve and the opening timing of the intake valve such that a second compression work associated with compression of in-cylinder gas in an exhaust stroke becomes smaller than a first compression work associated with compression of in-cylinder gas in a compression stroke.

### CROSS-REFERENCE TO RELATED APPLICATION

The present disclosure claims priority under 35 U.S.C. § 119 to Japanese Patent Application No. 2018-227427, filed on Dec. 4, 2018. The content of which is incorporated herein by reference in its entirety.

### BACKGROUND

### Technical Field

The present disclosure relates to an internal combustion engine system, and more particularly to an internal combustion engine system configured to perform a compression release brake using a variable valve operating device.

### Background Art

In a vehicle, a compression release brake using a variable valve operating device of an internal combustion engine is known as a way to enhance the engine brake when depression of an accelerator pedal is released. In this compression release brake, the engine brake is enhanced by opening and closing an exhaust valve at a timing different from that during normal operation in which the internal combustion engine performs a fuel injection to perform a combustion. On that basis, JP 2008-157195 A discloses a technique of using a variable valve operating device to make variable the engine braking force caused by the compression release brake.

To be more specific, the internal combustion engine disclosed in JP 2008-157195 A includes a variable valve operating device configured to change the lift amount of an exhaust valve by selecting a cam of a plurality of cams and driving the exhaust valve, and a variable valve operating device configured to change the phase of an exhaust camshaft between a phase associated with a normal operating state and a phase associated with an engine braking state. On that basis, when the engine brake is requested, these two variable valve operating devices are controlled so as to obtain a phase and a lift amount associated with the requested engine braking force. As a result, the engine braking force caused by the compression release brake can be controlled.

### SUMMARY

When the compression release brake described above is used, the exhaust valve is opened in the expansion stroke or the compression stroke after in-cylinder gas is compressed in the compression stroke. As a result, the compressed in-cylinder gas flows out to an exhaust gas passage vigorously. Thereafter, an intake valve is opened after the in-cylinder gas is compressed during the exhaust stroke in which the exhaust valve is closed. As a result, the compressed in-cylinder gas flows out to an intake air passage vigorously. Moreover, a silencer, such as a muffler, is arranged in the exhaust gas passage. Therefore, the sound produced when the in-cylinder gas compressed in the compression stroke flows out to the exhaust gas passage is hard to be transmitted to a passenger of the vehicle. On the other hand, the intake air passage is usually not provided with this kind of silencer. Therefore, it can be said that the sound produced when the in-cylinder gas compressed in the exhaust stroke flows out to the intake air passage is more easily transmitted to a passenger as compared to the sound due to the outflow of the in-cylinder gas compressed in the compression stroke. In order to ensure satisfactory passenger comfort, it is desirable to reduce the sound of the latter as possible.

The present disclosure has been made to address the problem described above, and an object of the present disclosure is to provide an internal combustion engine system that can enhance an engine braking force by the use of a compression release brake while reducing the sound produced when in-cylinder gas compressed in an exhaust stroke flows out to an intake air passage.

An internal combustion engine system according to the present disclosure includes: a fuel injection valve; a variable valve operating device configured to change at least an opening timing and closing timing of an exhaust valve among the opening timing and closing timing of the exhaust valve and an opening timing of an intake valve; and a control device configured to control the fuel injection valve and the variable valve operating device. The control device is configured, where depression of an accelerator pedal is released, to: execute a fuel cut processing to control the fuel injection valve so as to stop fuel injection; and execute an engine braking enhancement processing to control the variable valve operating device so as to advance the opening timing and closing timing of the exhaust valve as compared to during execution of the fuel injection. The engine braking enhancement processing includes a noise reduction processing to adjust at least one of the closing timing of the exhaust valve and the opening timing of the intake valve such that a second compression work associated with compression of in-cylinder gas in an exhaust stroke becomes smaller than a first compression work associated with compression of in-cylinder gas in a compression stroke.

In the noise reduction processing reduces, the second compression work may be reduced as compared to the first compression work by adjusting an amount of retard of the closing timing of the exhaust valve with respect to an expansion bottom dead center.

In the noise reduction processing, the second compression work may be reduced as compared to the first compression work by adjusting an amount of advance of the opening timing of the intake valve with respect to an exhaust top dead center.

According to the internal combustion engine system of the present disclosure, where depression of the accelerator pedal is released, the engine braking enhancement processing associated with the noise reduction processing is executed together with the fuel cut processing. According to the noise reduction processing, at least one of the closing timing of the exhaust valve and the opening timing of the intake valve is adjusted such that the second compression work becomes smaller than the first compression work. Thus, the difference between the in-cylinder pressure at the opening of the intake valve and the pressure in an intake air passage can be made smaller than the difference between the in-cylinder pressure at the opening of the exhaust valve and the pressure in an exhaust gas passage. Therefore, according to the internal combustion engine system of the present disclosure, it is possible to enhance the engine braking force by the use of the compression release brake while reducing the sound produced when the in-cylinder gas compressed in the exhaust stroke flows out to the intake air passage.

### BRIEF DESCRIPTION OF THE DRAWINGS

FIG. 1 is a schematic diagram that illustrates a configuration example of an internal combustion engine system according to a first embodiment of the present disclosure;

FIG. 2 is a diagram used to describe the operating principle of a compression release brake;

FIG. 3 is a diagram that illustrates an example of conventional intake and exhaust valve timings used for achieving the compression release brake;

FIG. 4 is a diagram that illustrates a relationship between the intake and exhaust valve timings and in-cylinder pressure in a comparative example in which the compression release brake is performed under the intake and exhaust valve timings shown in FIG. 3;

FIG. 5 is a diagram that illustrates an example of intake and exhaust valve timings used in an engine braking enhancement processing associated with a noise reduction processing according to the first embodiment of the present disclosure;

FIG. 6 is a diagram used to describe a relationship between the intake and exhaust valve timings and in-cylinder pressure in an example (first embodiment) in which the compression release brake is performed under the intake and exhaust valve timings shown in FIG. 5, in comparison with the comparative example shown in FIG. 4;

FIG. 7 is a flowchart that illustrates a routine of the processing concerning an engine control at the time of release of depression of an accelerator pedal according to the first embodiment of the present disclosure;

FIG. 8 is a diagram that illustrates an example of intake and exhaust valve timings used in an engine braking enhancement processing associated with a noise reduction processing according to a second embodiment of the present disclosure;

FIG. 9 is a diagram used to describe a relationship between the intake and exhaust valve timings and in-cylinder pressure in an example (second embodiment) in which the compression release brake is performed under the intake and exhaust valve timings shown in FIG. 8, in comparison with the comparative example shown in FIG. 4; and

FIG. 10 is a diagram that illustrates an example of intake and exhaust valve timings used in an engine braking enhancement processing associated with a noise reduction processing according to a third embodiment of the present disclosure.

### DETAILED DESCRIPTION

In the following, embodiments of the present disclosure will be described with reference to the accompanying drawings. However, it is to be understood that even when the number, quantity, amount, range or other numerical attribute of an element is mentioned in the following description of the embodiments, the present disclosure is not limited to the mentioned numerical attribute unless explicitly described otherwise, or unless the present disclosure is explicitly specified by the numerical attribute theoretically. Furthermore, structures or steps or the like that are described in conjunction with the following embodiments are not necessarily essential to the present disclosure unless explicitly shown otherwise, or unless the present disclosure is explicitly specified by the structures, steps or the like theoretically.

### 1. First Embodiment

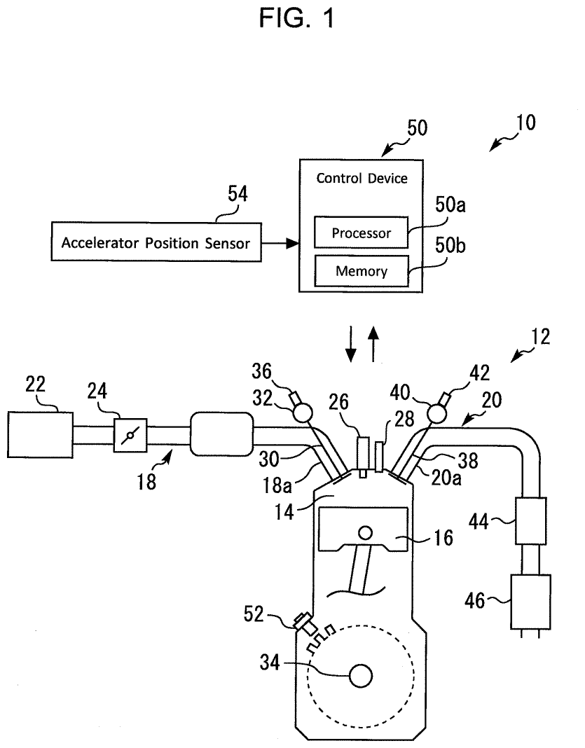

A first embodiment according to the present disclosure will be described with reference to FIGS. 1 to 7.

### 1-1. Configuration Example of Internal Combustion Engine System

FIG. 1 is a schematic diagram that illustrates a configuration example of an internal combustion engine system 10 according to the first embodiment of the present disclosure. The internal combustion engine system 10 shown in FIG. 1 includes an internal combustion engine 12 which is a four-stroke reciprocating engine. The internal combustion engine 12 is, as an example, a spark ignition type internal combustion engine (for example, a gasoline engine) and is mounted on a vehicle and used as a power source thereof. It should be noted that the internal combustion engine 12 is an in-line four-cylinder engine as an example, but the number of cylinders and the arrangement of cylinders of the internal combustion engine 12 are not particularly limited. The internal combustion engine included in the internal combustion engine system according to the present disclosure may be a compression ignition type instead of the spark ignition type.

A piston 16 is arranged in each cylinder 14 of the internal combustion engine 12. The piston 16 reciprocates inside the cylinder 14. An intake air passage 18 and an exhaust gas passage 20 communicate with each of the cylinders 14 (combustion chambers). An air cleaner 22 is provided at the inlet of the intake air passage 18. An electronically controlled throttle valve 24 is arranged in the intake air passage 18 downstream of the air cleaner 22.

The internal combustion engine 12 also includes fuel injection valves 26 and an ignition device 28. Each of the fuel injection valves 26 is arranged in the corresponding cylinder 14 and directly injects fuel into the corresponding cylinder 14. It should be noted that, in each cylinder 14, a fuel injection valve that injects fuel into an intake port 18a of the intake air passage 18 may be provided instead of or in addition to the fuel injection valve 26.

The intake ports 18a are respectively opened and closed by intake valves 30. The intake valves 30 are driven by an intake variable valve operating device 32. As an example of the intake variable valve operating device 32 is a variable valve timing device configured to change the rotational phase of an intake camshaft (not shown) with respect to the rotational phase of a crankshaft 34, and is hereafter also referred to as an “intake VVT 32”. The intake VVT 32 is, for example, an electrically driven type or a hydraulically driven type. According to the intake VVT 32, it is possible to continuously change the opening and closing timings (i.e., the phase of the valve opening duration) of the intake valves 30 within a designated control range while fixing the operating angle of the intake valves 30 (i.e., the valve opening duration thereof (more specifically, the crank angle width in which the intake valves 30 are open)). An intake camshaft angle sensor 36 that outputs a signal responsive to the rotational phase of the intake camshaft (i.e., intake cam angle) is arranged in the vicinity of the intake camshaft.

Exhaust ports 20a of the exhaust gas passage 20 are respectively opened and closed by exhaust valves 38. The exhaust valves 38 are driven by an exhaust variable valve operating device 40. As an example, the exhaust variable valve operating device 40 is also a variable valve timing device similar to the intake VVT 32, and is hereafter also referred to as an “exhaust VVT 40”. An exhaust cam angle sensor 42 that outputs a signal responsive to the rotational phase of an exhaust camshaft (not shown) (i.e., exhaust cam angle) is arranged in the vicinity of the exhaust camshaft. Any desired number of exhaust gas purifying catalysts 44 and a muffler 46 are arranged in the exhaust gas passage 20 in order from the upstream side of the exhaust gas flow.

The internal combustion engine system 10 according to the present embodiment is further provided with a control device 50 for controlling the internal combustion engine 12. The control device 50 is an electronic control unit (ECU) including a processor 50a and a memory 50b. The memory 50b stores various programs for controlling the internal combustion engine 12. The processor 50a reads out a program from the memory 50b and executes the program. It should be noted that the control device 50 may be configured with a plurality of ECUs.

The control device 50 receives sensor signals from various sensors. The various sensors include, for example, a crank angle sensor 52 and an accelerator position sensor 54 in addition to the intake cam angle sensor 36 and the exhaust cam angle sensor 42 that are described above. The crank angle sensor 52 outputs a signal responsive to the crank angle θ. The control device 50 can calculate the engine speed by the use of signals from the crank angle sensor 52. The accelerator position sensor 54 outputs a signal responsive to the amount of depression of an accelerator pedal of the vehicle on which the internal combustion engine 12 is mounted. In addition, the processor 50a executes various programs by the use of the received sensor signals, and also outputs actuating signals for controlling the actuators described above, that is, the throttle valve 24, the fuel injection valves 26, the ignition device 28, the intake VVT 32, and the exhaust VVT 40.

### 1-2. Engine Control When Depression of Accelerator Pedal Is Released

According to the present embodiment, when depression of the accelerator pedal is released by the driver of the vehicle, the control device 50 closes the throttle valve 24 and executes a “fuel cut processing” and an “engine braking enhancement processing” on condition that designated execution conditions described below be met (see steps S102 and S106 described below). According to the fuel cut processing, the fuel injection valves 26 for the respective cylinders 14 are controlled so as to stop the fuel injection. According to the engine braking enhancement processing, in order to enhance the engine braking force when depression of the accelerator pedal is released (that is, during the deceleration of the vehicle), a “compression release brake” is performed by the use of the exhaust VVT 40.

### 1-2-1. Operating Principle of Compression Release Brake

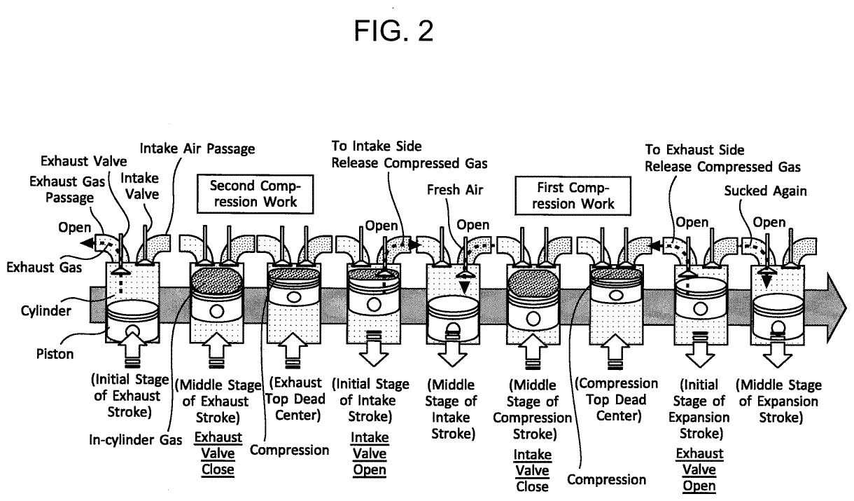

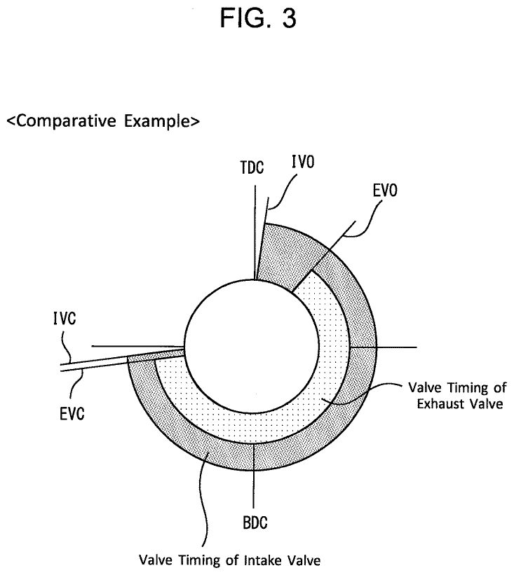

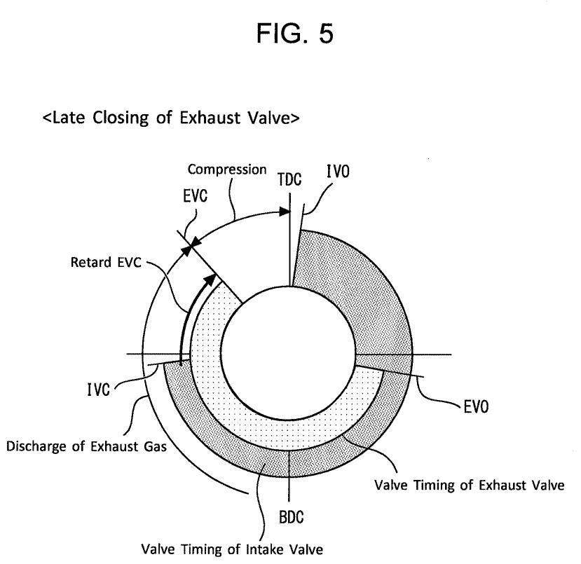

FIG. 2 is a diagram used to describe the operating principle of the compression release brake. FIG. 3 is a diagram that illustrates an example of conventional intake and exhaust valve timings used for achieving the compression release brake. According to the intake and exhaust valve timings shown in FIG. 3, the exhaust valve is opened in the initial stage of the expansion stroke and then closed in the middle stage of the exhaust stroke, and, on the other hand, the intake valve is opened in the initial stage of the intake stroke and then closed in the middle stage of the compression stroke. It should be noted that the intake and exhaust valve timings shown in FIG. 3 (which correspond to a comparative example with respect to the first embodiment) are used here for the purpose of explaining the operating principle of the compression release brake as a premise. Therefore, this is different from the intake and exhaust valve timings finally used in the present embodiment (in other words, intake and exhaust valve timings according to the “engine braking enhancement processing” associated with a “noise reduction processing” described below with reference to FIG. 5).

During the deceleration of the vehicle (normal vehicle deceleration) in which fuel injection is stopped in response to depression of the accelerator pedal being released without using the compression release brake, a compression work associated with the compression of the in-cylinder gas in the compression stroke is performed. That is to say, one compression work is performed during one cycle of the internal combustion engine (i.e., each stroke of intake, compression, expansion, and exhaust). In contrast to this, during the deceleration of the vehicle associated with the compression release brake, as shown in FIG. 2, two compression works (first and second compression works described below) are performed in one cycle in order to enhance the engine braking force.

In detail, the fresh air (in-cylinder gas) taken into the cylinder during the intake stroke is compressed during the compression stroke after the intake valve is closed. According to the example shown in FIG. 2, the compressed in-cylinder gas is discharged to the exhaust gas passage in response to the opening of the exhaust valve in the initial stage of the expansion stroke, and as a result, a compression work occurs. Hereafter, for convenience of description, the compression work associated with the compression of the in-cylinder gas in the compression stroke is referred to as a “first compression work”. It should be noted that the closing timing EVC of the exhaust valve for obtaining the first compression work may be set in the compression stroke (for example, immediately before the compression top dead center), instead of the expansion stroke.

Furthermore, in the expansion stroke after the compressed in-cylinder gas is released in the initial stage of the expansion stroke, as shown in FIG. 2, the air discharged to the exhaust gas passage is sucked into the cylinder again. The air (in-cylinder gas) sucked again in this manner is compressed after the exhaust valve is closed in the middle stage of the subsequent exhaust stroke. The compressed in-cylinder gas is then discharged to the intake air passage in response to the opening of the intake valve in the initial stage of the intake stroke, and as a result, another compression work occurs. Hereafter, for convenience of description, the compression work associated with the compression of the in-cylinder gas in the exhaust stroke is referred to as a “second compression work”.

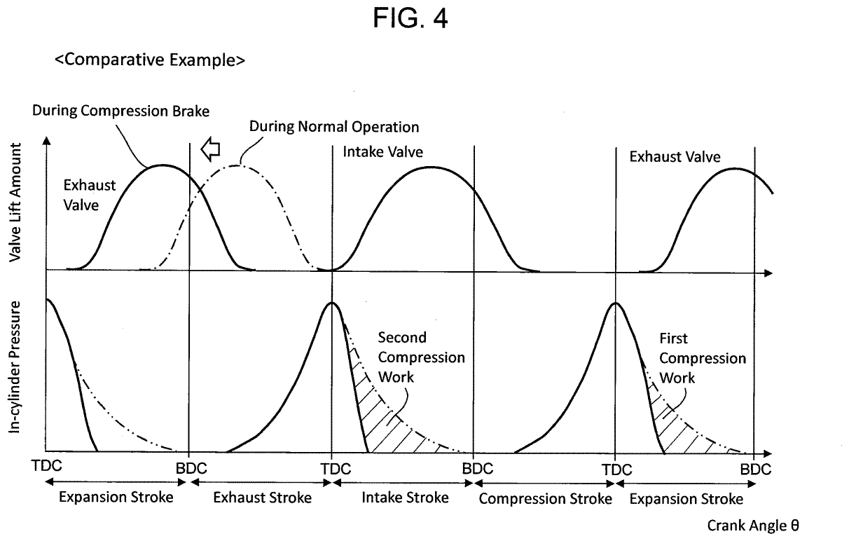

FIG. 4 is a diagram that illustrates a relationship between the intake and exhaust valve timings and the in-cylinder pressure in the comparative example in which the compression release brake is performed under the intake and exhaust valve timings shown in FIG. 3. The horizontal axis in FIG. 4 denotes the crank angle θ. The lift curve of the exhaust valve shown by a one-dot line in FIG. 4 is an example of a lift curve used in the normal operation in which the internal combustion engine performs a fuel injection to perform a combustion). When the compression release brake is used, as shown in FIG. 4, the opening timing and the closing timing of the exhaust valve are advanced as compared to during the normal operation.

Waveforms of the in-cylinder pressure shown by two-dot chain lines in FIG. 4 correspond to a waveform of the in-cylinder pressure obtained when the exhaust valve is not opened after the compression of the in-cylinder gas in the compression stroke and a waveform of the in-cylinder pressure obtained when the intake valve is not opened after the compression of the in-cylinder gas in the exhaust stroke. When the exhaust valve or the intake valve is not opened in this manner, as shown in FIG. 4, the in-cylinder pressure gradually decreases as compared to when the exhaust valve or the intake valve is opened (i.e., when the compressed in-cylinder gas is released (solid lines)). As a result, the compression pressure of the in-cylinder gas compressed in the compression stroke or the exhaust stroke acts so as to assist the piston in descending in the subsequent expansion stroke or intake stroke.

On the other hand, when the exhaust valve or the intake valve is opened in the expansion stroke or the intake stroke, as shown by the solid lines in FIG. 4, the compressed in-cylinder gas vigorously flows out into the exhaust gas passage or the intake air passage, and thus, the in-cylinder pressure rapidly decreases. As a result, the compression pressure of the in-cylinder gas compressed in the compression stroke or the exhaust stroke is released to the outside of the cylinder, and is thus not used to assist the piston in descending in the subsequent expansion stroke or intake stroke. In other words, by opening the exhaust valve or the intake valve to release the compression pressure of the in-cylinder gas to the outside, the first and second compression works serving as the engine braking force are obtained.

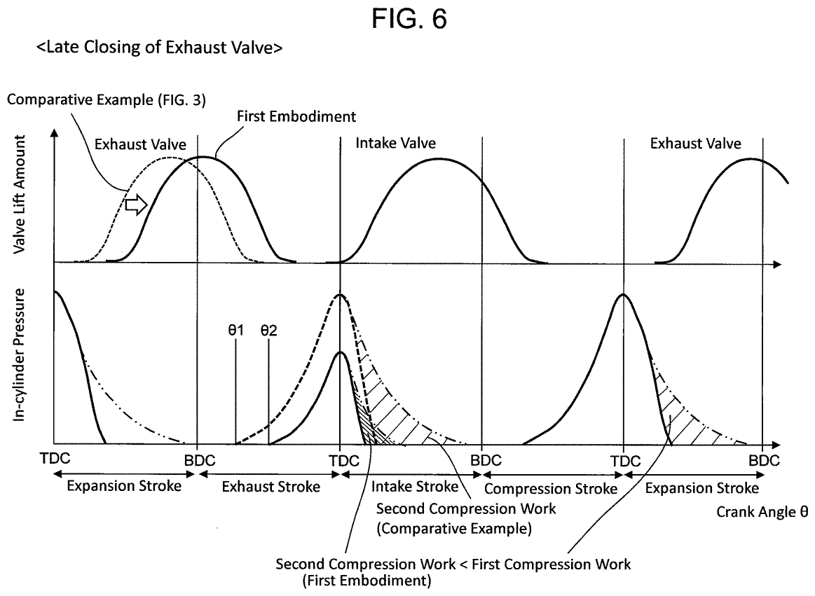

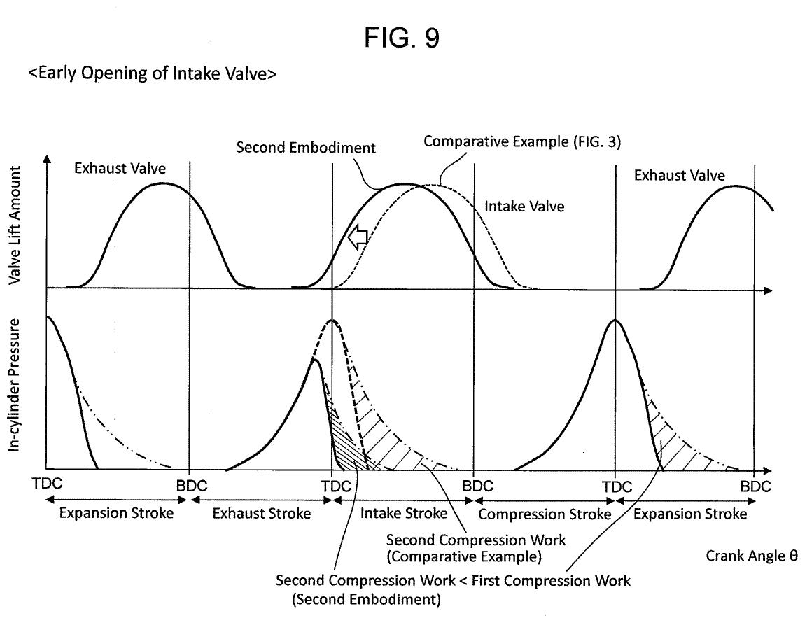

In addition, the magnitude of the compression work can typically be expressed by a P-V diagram that represents a relationship between the in-cylinder pressure P and the in-cylinder volume V. To be more specific, the area of a region on the P-V diagram associated with a crank angle width in which the piston moves from the bottom dead center to the next bottom dead center (i.e., crank angle width in which the compression of the cylinder gas is performed in the process of the piston moving from the bottom dead center to the top dead center, and the piston then returns from the top dead center to the bottom dead center) corresponds to the magnitude of the compression work. Although illustration of the P-V diagram itself is omitted here, the region can also be grasped on a P-θ diagram as shown in FIG. 4 (also in FIGS. 6 and 9 described below). That is to say, each in-cylinder pressure waveform of the expansion stroke shown by the two-dot chain line in FIG. 4 is line-symmetric with respect to the in-cylinder pressure waveform of the compression stroke shown by the solid line on the P-θ diagram with reference to the compression top dead center (TDC). Moreover, a P-V diagram in the crank angle width in which the piston moves from the intake bottom dead center to the next expansion bottom dead center is obtained by turning back the compression stroke and expansion stroke of the P-θ diagram with reference to the compression top dead center. Because of this, the magnitude of the first compression work can be represented by the area of the hatched portion shown in FIG. 4. This also applies to the magnitude of the second compression work in the exhaust stroke and the intake stroke, as shown in FIG. 4.

### 1-2-2. Issue on Use of Compression Release Brake

A silencer, such as a muffler, is arranged in an exhaust gas passage of an internal combustion engine. Because of this, the sound produced when the in-cylinder gas compressed in the compression stroke flows out to the exhaust gas passage is hard to be transmitted to a passenger of the vehicle. In more detail, in the example of the exhaust gas passage 20 shown in FIG. 1, the exhaust gas purifying catalysts 44 together with the muffler 46 acts so as to reduce the sound described above. On the other hand, an intake air passage is usually not provided with this kind of silencer. Because of this, it can be said that the sound produced when the in-cylinder gas compressed in the exhaust stroke flows out to the intake air passage is easily transmitted to a passenger as compared to the sound due to the outflow of the in-cylinder gas compressed in the compression stroke. In order to ensure satisfactory passenger comfort, it is desirable to reduce the sound of the latter as possible.

1-2-3. Engine Braking Enhancement Processing Associated with Noise Reduction Processing According to First Embodiment

According to the “engine braking enhancement processing” of the present embodiment using the compression release brake as described above, the exhaust VVT 40 is controlled so as to advance the opening timing EVO of the exhaust valve 38 in the expansion stroke and the closing timing EVC of the exhaust valve 38 in the exhaust stroke, as compared to during the execution of fuel injection (i.e., during the normal operation).

On that basis, in view of the issue described above, the present engine braking enhancement processing is performed with the following “noise reduction processing”. According to this noise reduction processing, the closing timing EVC of the exhaust valve 38 is adjusted such that the second compression work associated with the compression of the in-cylinder gas in the exhaust stroke becomes smaller than the first compression work associated with the compression of the in-cylinder gas in the compression stroke.

FIG. 5 is a diagram that illustrates an example of intake and exhaust valve timings used in the engine braking enhancement processing associated with the noise reduction processing according to the first embodiment of the present disclosure. It should be noted that, as shown in FIG. 5, the valve timing of the intake valve 30 is, as an example, the same as the valve timing of the intake valve in the comparative example shown in FIG. 3.

As can be seen from a comparison between FIG. 3 and FIG. 5, the closing timing EVC of the exhaust valve 38 in the example shown in FIG. 5 (first embodiment) is retarded as compared to the closing timing EVC in the comparative example shown in FIG. 3. To be more specific, the amount of retard of the closing timing EVC with respect to the bottom dead center of expansion is increased. As a result, the amount of gas discharged to the exhaust gas passage 20 during the opening of the exhaust valve 38 in the exhaust stroke increases, and thus, the amount of in-cylinder gas compressed in the subsequent exhaust stroke decreases. In addition, as a result of the retard of the closing timing EVC, the crank angle width in which the in-cylinder gas is compressed during the exhaust stroke is shortened.

FIG. 6 is a diagram used to describe a relationship between the intake and exhaust valve timings and the in-cylinder pressure in an example (i.e., first embodiment) in which the compression release brake is performed under the intake and exhaust valve timings shown in FIG. 5, in comparison with the comparative example shown in FIG. 4.

According to the intake and exhaust valve timings shown in FIG. 5 associated with the noise reduction processing of the present embodiment, the closing timing EVC of the exhaust valve 38 is retarded as compared to the comparative example shown in FIG. 4. As a result, in the example in which the noise reduction processing is used, a crank angle θ2 at which compression is started during the exhaust stroke is retarded as compared to a crank angle θ1 in the comparative example. Moreover, in the example in which the noise reduction processing is used, as described above, the amount of gas compressed in the exhaust stroke is reduced as compared to the amount of compressed gas in the comparative example shown in FIG. 4. Because of this, as can be seen from a comparison between the in-cylinder pressure waveforms shown by the solid line and broken line in FIG. 6, where the noise reduction processing is used, the level of increase in the in-cylinder pressure due to the compression of the in-cylinder gas in the exhaust stroke is lowered as compared to the comparative example, and as a result, the second compression work (i.e., the area of the hatched portion) is reduced.

The retard amount of the closing timing EVC used in the noise reduction processing according to the present embodiment (i.e., the retard amount with respect to the expansion top dead center) is determined such that the second compression work is smaller than the first compression work by the use of the reduction of the second compression work achieved as described above. In addition, in an example where the exhaust VVT 40 by which the opening timing EVO changes in synchronization with the change of the closing timing EVC is used, the amount of retard of the closing timing EVC is determined such that the second compression work becomes smaller than the first compression work with the change of the opening timing EVO also taken into consideration.

### 1-2-3. Processing by Control Device

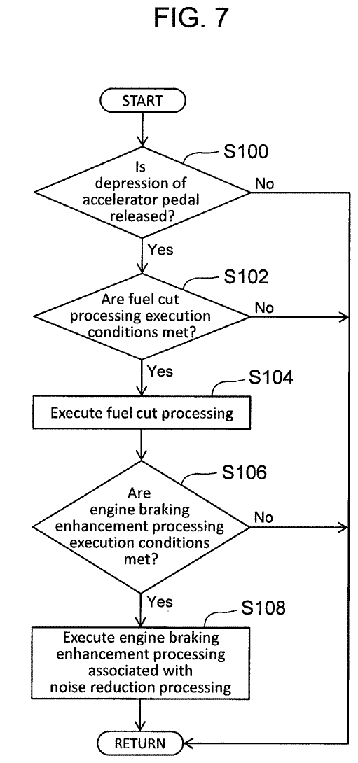

FIG. 7 is a flowchart that illustrates a routine of the processing concerning the engine control at the time of the release of depression of the accelerator pedal according to the first embodiment of the present disclosure. The control device 50 repeatedly executes the processing of this routine during the operation of the internal combustion engine 12.

According to the routine shown in FIG. 7, first, in step S100, the control device 50 determines whether or not depression of the accelerator pedal is released by the use of the accelerator position sensor 54. As a result, if the determination result of step S100 is negative, that is, if the vehicle is not decelerating, the control device 50 ends the current processing cycle.

If, on the other hand, the determination result of step S100 is positive, the processing proceeds to step S102. In step S102, the control device 50 determines whether or not designated fuel cut processing executing conditions are met. The fuel cut processing execution conditions include, for example, a condition that the engine speed is equal to or higher than a designated value when depression of the accelerator pedal is released. Moreover, in an example of a hybrid vehicle including an electric motor as its power sources in addition to the internal combustion engine 12, the fuel cut processing execution conditions may include, for example, a condition that an engine stop is available.

If the determination result of step S102 is negative, the control device 50 ends the current processing cycle. If, on the other hand, this determination result is positive, the processing proceeds to step S104. In step S104, the control device 50 executes the fuel cut processing described above. Thereafter, the processing proceeds to step S106.

In step S106, the control device 50 determines whether or not designated engine braking enhancement processing executing conditions are met. The engine braking enhancement processing execution conditions include, for example, a condition that there is a request to reduce an increase in the engine speed in response to the execution of the fuel cut processing. Moreover, in the example of the hybrid vehicle described above, the engine braking enhancement processing execution conditions may include, for example, a condition that regenerative braking is not available.

If the determination result of step S106 is negative, the control device 50 ends the current processing cycle. If, on the other hand, this determination result is positive, the processing proceeds to step S108. In step S108, the control device 50 executes the engine braking enhancement processing associated with the noise reduction processing described above. In more detail, a target value of the closing timing EVC of the exhaust valve 38 used in the present engine braking enhancement processing is determined in advance and stored in the memory 50b of the control device 50. The control device 50 controls the exhaust VVT 40 such that the actual closing timing EVC obtained by the use of the crank angle sensor 52 and the exhaust cam angle sensor 42 becomes equal to the target value.

### 1-3. Advantageous Effect

As described above, according to the engine braking enhancement processing associated with the noise reduction processing according to the first embodiment, the closing timing EVC of the exhaust valve 38 is adjusted such that, when enhancing the engine braking force by the use of the compression release brake, the second compression work (exhaust stroke to intake stroke) becomes smaller than the first compression work (compression stroke to expansion stroke). As a result, the difference between the in-cylinder pressure at the opening of the intake valve 30 and the pressure in the intake air passage 18 can be made smaller than the difference between the in-cylinder pressure at the opening of the exhaust valve 38 and the pressure in the exhaust gas passage 20. Because of this, it is possible to enhance the engine braking force at the time of the release of depression of the accelerator pedal while reducing the sound produced in response to the opening of the intake valve 30.

### 2. Second Embodiment

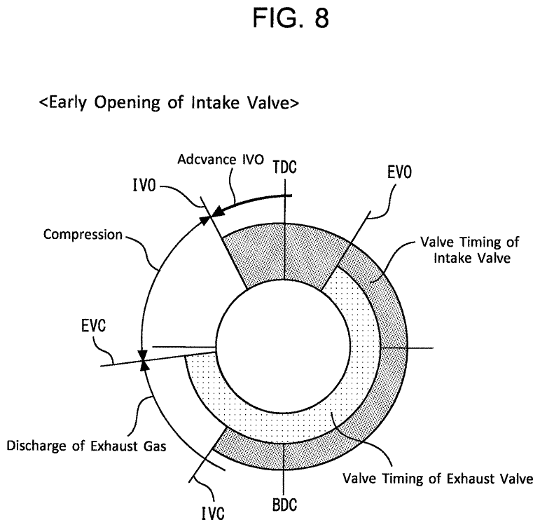

Then, a second embodiment according to the present disclosure will be described with reference to FIGS. 8 and 9. In the following description, it is assumed that the configuration shown in FIG. 1 is used as an example of the hardware configuration of an internal combustion engine system according to the second embodiment. This also applies to a third embodiment described below.

2-1. Engine Braking Enhancement Processing Associated with Noise Reduction Processing According to Second Embodiment

An engine braking enhancement processing according to the second embodiment is different from the engine braking enhancement processing according to the first embodiment in that the contents of the “noise reduction processing” differs as follows.

FIG. 8 is a diagram that illustrates an example of intake and exhaust valve timings used in the engine braking enhancement processing associated with the noise reduction processing according to the second embodiment of the present disclosure. The noise reduction processing according to the present embodiment is different from the noise reduction processing according to the first embodiment in that the advance of an opening timing IVO of the intake valve 30 is used instead of the retard of the closing timing EVC of the exhaust valve 38.

To be more specific, as shown in FIG. 8, the intake valve 30 is opened during the exhaust stroke after the in-cylinder gas is compressed in response to the closing of the exhaust valve 38 in the exhaust stroke. In other words, the opening timing IVO of the intake valve 30 is advanced as compared to the exhaust top dead center while achieving a negative valve overlap period in which the exhaust valve 38 and the intake valve 30 are both closed in the exhaust stroke. It should be noted that the valve timing of the exhaust valve 38 shown in FIG. 8 is, as an example, the same as the valve timing of the exhaust valve in the comparative example shown in FIG. 3.

FIG. 9 is a diagram used to describe a relationship between the intake and exhaust valve timings and the in-cylinder pressure in the example (second embodiment) in which the compression release brake is performed under the intake and exhaust valve timings shown in FIG. 8, in comparison with the comparative example shown in FIG. 4.

If the opening timing IVO of the intake valve 30 is advanced, as compared to the exhaust top dead center, by the noise reduction processing according to the present embodiment, the intake valve 30 is opened during compression of the in-cylinder gas in the exhaust stroke, and the compressed pressure is released to the intake air passage 18. Because of this, as can be seen from a comparison between the in-cylinder pressure waveforms of the solid line and broken line in FIG. 9, the noise reduction processing according to the present embodiment also lowers the level of increase in the in-cylinder pressure in response to the compression of the in-cylinder gas in the exhaust stroke as compared to the comparative example shown in FIG. 4, and as a result, the second compression work (i.e., the area of the hatched portion) is reduced.

The amount of advance of the opening timing IVO used in the noise reduction processing according to the present embodiment (i.e., the amount of advance with respect to the exhaust top dead center) is determined such that the second compression work is made smaller than the first compression work by the use of the reduction of the second compression work achieved as described above. In addition, in an example where the intake VVT 32 by which the closing timing IVC changes in synchronization with the change in the opening timing IVO is used, the amount of advance of the opening timing IVO is determined such that the second compression work becomes smaller than the first compression work with the change in the closing timing IVC also taken into consideration.

It should be noted that, since the processing of the routine for performing the engine braking enhancement processing according to the present embodiment can be executed in the similar manner to the processing of the routine shown in FIG. 7 according to the first embodiment, the detailed description thereof is omitted here.

### 2-2. Advantageous Effect

As described so far, according to the engine braking enhancement processing associated with the noise reduction processing according to the second embodiment, the opening timing IVO of the intake valve 30 is adjusted such that, when enhancing the engine braking force by the use of the compression release brake, the second compression work (exhaust stroke to intake stroke) becomes smaller than the first compression work (compression stroke to expansion stroke). According to this kind of adjustment of the opening timing IVO, again, the difference between the in-cylinder pressure at the opening of the intake valve 30 and the pressure in the intake air passage 18 can be made smaller than the difference between the in-cylinder pressure at the opening of the exhaust valve 38 and the pressure in the exhaust gas passage 20. Because of this, also in the present embodiment, it is possible to enhance the engine braking force at the time of the release of depression of the accelerator pedal while reducing the sound produced in response to the opening of the intake valve 30.

### 3. Third Embodiment

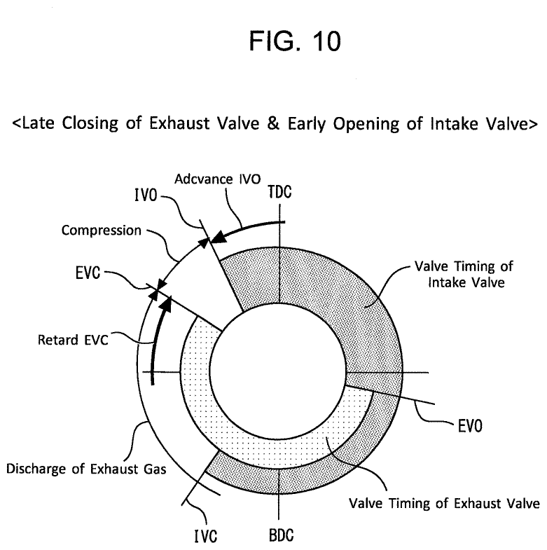

Then, a third embodiment according to the present disclosure will be described with reference to FIG. 10. An engine braking enhancement processing according to the third embodiment is different from the engine braking enhancement processing according to the first and second embodiments in that the contents of the “noise reduction processing” differs as follows.

FIG. 10 is a diagram that illustrates an example of intake and exhaust valve timings used in the engine braking enhancement processing associated with the noise reduction processing according to the third embodiment of the present disclosure. According to the noise reduction processing of the present embodiment, in order to make the second compression work smaller than the first compression work, as shown in FIG. 10, both of the retard of the closing timing EVC of the exhaust valve 38 described in the first embodiment and the advance of the opening timing IVO of the intake valve 30 described in the second embodiment are used. This measure which is a combination of the manners according to the first and second embodiments as just described may be performed in order to enhance the engine braking force while reducing the sound produced in response to the opening of the intake valve 30.

### 4. Other Examples of Variable Valve Operating Device

In the first to third embodiments described above, the intake variable valve operating device (intake VVT) 32 and the exhaust variable valve operating device (exhaust VVT) 40 each correspond to an example of the “variable valve operating device” according to the present disclosure. However, the “variable valve operating device” according to the present disclosure may be a device of the “variable operating angle type” configured to continuously change the operating angle of a valve, instead of a device of the “fixed operating angle type”, such as the intake VVT 32 or the exhaust VVT 40, as long as the “variable valve operating device” can perform the valve operation required in the engine braking enhancement processing associated with the noise reduction processing.

Specifically, in another example of the noise reduction processing (second embodiment) that uses an early opening of the intake valve, the opening timing IVO may be advanced with respect to the exhaust top dead center without changing the closing timing IVC of the intake valve by using a device of the variable operating angle type. In still another example in which a device of the variable operating angle type is used to drive the exhaust valve, each of the opening timing EVO and the closing timing EVC may be changed to perform the noise reduction processing while changing the operating angle with respect to the valve timing of the exhaust valve for the normal operation.

Moreover, in order to perform the noise reduction processing (first embodiment) that uses a late closing of the exhaust valve, a device configured to change the opening timing IVO of the intake valve may not always be included. Thus, in another example of the internal combustion engine system that performs this noise reduction processing (using the late closing of the exhaust valve), an internal combustion engine including the exhaust VVT 40 but not including the intake VVT 32 may be used, for example, instead of the internal combustion engine 12 including both of the intake VVT 32 and the exhaust VVT 40.

Furthermore, examples of the variable valve operating device according to the present disclosure are not limited to a variable valve timing device configured to change the rotational phase of a camshaft with respect to the rotational phase of a crankshaft, such as the intake VVT 32 or the exhaust VVT 40. That is to say, another example of the variable valve operating device according to the present disclosure may be a device in which a cam for driving a valve (intake valve or exhaust valve) is selected from a plurality of cams having different cam profiles. In detail, for example, a variable valve operating device including a device configured to shift the position of a plurality of cams in an axial direction of a camshaft may be used to switch a cam for driving a valve. In addition, for example, a variable valve operating device may be used which includes a plurality of rocker arms each operating in synchronization with a plurality of cams, and which is configured to switch a earn for driving a valve by selecting a rocker arm used to drive the valve from the plurality of rocker arms.

The embodiments and modification examples described above may be combined in other ways than those explicitly described above as required and may be modified in various ways without departing from the scope of the present disclosure.

What is claimed is:

1. An internal combustion engine system, comprising:
a fuel injection valve;
a variable valve operating device configured to change at least an opening timing and closing timing of an exhaust valve among the opening timing and closing timing of the exhaust valve and an opening timing of an intake valve; and
a control device configured to control the fuel injection valve and the variable valve operating device,
wherein the control device is configured, where depression of an accelerator pedal is released, to:
execute a fuel cut processing to control the fuel injection valve so as to stop fuel injection; and
execute an engine braking enhancement processing to control the variable valve operating device so as to advance the opening timing and closing timing of the exhaust valve as compared to during execution of the fuel injection, and
wherein the engine braking enhancement processing includes a noise reduction processing to adjust at least one of the closing timing of the exhaust valve and the opening timing of the intake valve such that a second compression work associated with compression of in-cylinder gas in an exhaust stroke becomes smaller than a first compression work associated with compression of in-cylinder gas in a compression stroke.

2. The internal combustion engine system according to claim 1,
wherein the noise reduction processing reduces the second compression work as compared to the first compression work by adjusting an amount of retard of the closing timing of the exhaust valve with respect to an expansion bottom dead center.

3. The internal combustion engine system according to claim 1,
wherein the noise reduction processing reduces the second compression work as compared to the first compression work by adjusting an amount of advance of the opening timing of the intake valve with respect to an exhaust top dead center.
